(19) United States
(12) Patent Application Publication
(10) Pub. No.: US 2014/0174347 A1
(43) Pub. Date: Jun. 26, 2014

(54) MOUNTING ASSEMBLY FOR ADHESIVE DISPENSER AND ADHESIVE DISPENSER USING SAME

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: TENG-TSUNG HUANG, New Taipei (TW); GONG-SHUI CHENG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/970,975

(22) Filed: Aug. 20, 2013

(30) Foreign Application Priority Data
Dec. 25, 2012 (CN) 2012105695116

(51) Int. Cl. B05C 11/00

(52) U.S. Cl. CPC B05C 11/00
USPC 118/323; 222/160

(57) ABSTRACT

A mounting assembly for an adhesive dispenser includes a sliding board, a first fixing board, and a second fixing board. The sliding board includes two sliding rails on two opposite sides thereof. An adhesive container is mounted on the sliding board. The first fixing board includes a first sliding groove. The second fixing board defines a second sliding groove corresponding to the first sliding groove. The first fixing board and the second fixing board are mounted on the adhesive dispenser and opposite to each other, the sliding board is slidably attached to the first fixing board and the second fixing board with the two sliding rails slidably receiving the first, second sliding grooves. When replacing the adhesive container, the sliding board is slipped out of the first sliding groove and the second sliding groove. Thus, the adhesive container can be easily removed and replaced by users.

### BACKGROUND

1. Technical Field

The present disclosure relates to a mounting assembly for an adhesive dispenser and an adhesive dispenser using the mounting assembly.

2. Description of Related Art

An adhesive dispenser commonly includes an adhesive container fastened thereon. The adhesive container contains adhesive to be dispensed on workpieces. Sometimes, the adhesive container must be replaced with another adhesive container with different capacity according to different requirements for adhesives. However, since the adhesive container is fastened on the adhesive dispenser, it is difficult to replace only the adhesive containers.

Therefore, there is room for improvement within the art.

### BRIEF DESCRIPTION OF THE FIGURES

Many aspects of the disclosure can be better understood with reference to the following figures. The components in the figures are not necessarily drawn to scale, the emphasis instead being placed upon clearly illustrating the principles of the disclosure. Moreover, in the drawings, like reference numerals designate corresponding parts throughout the several views.

FIG. 1 is an isometric view of an exemplary embodiment of a mounting assembly mounted on an adhesive dispenser.

FIG. 2 is a sectional view of the adhesive dispenser of FIG. 1.

FIG. 3 is an exploded view of the mounting assembly of FIG. 1.

### DETAILED DESCRIPTION

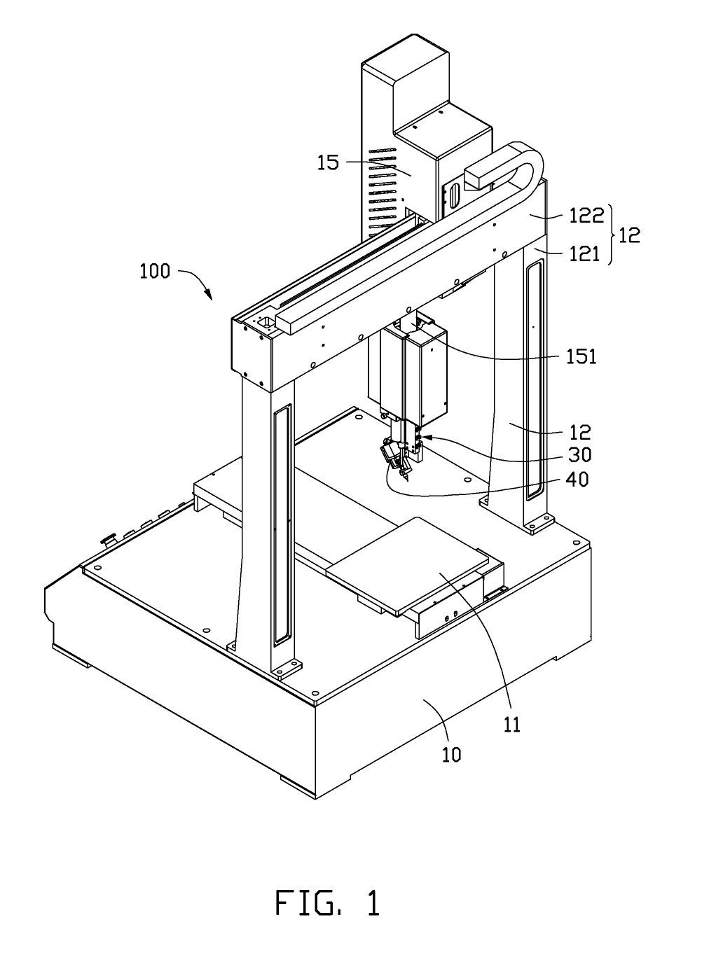

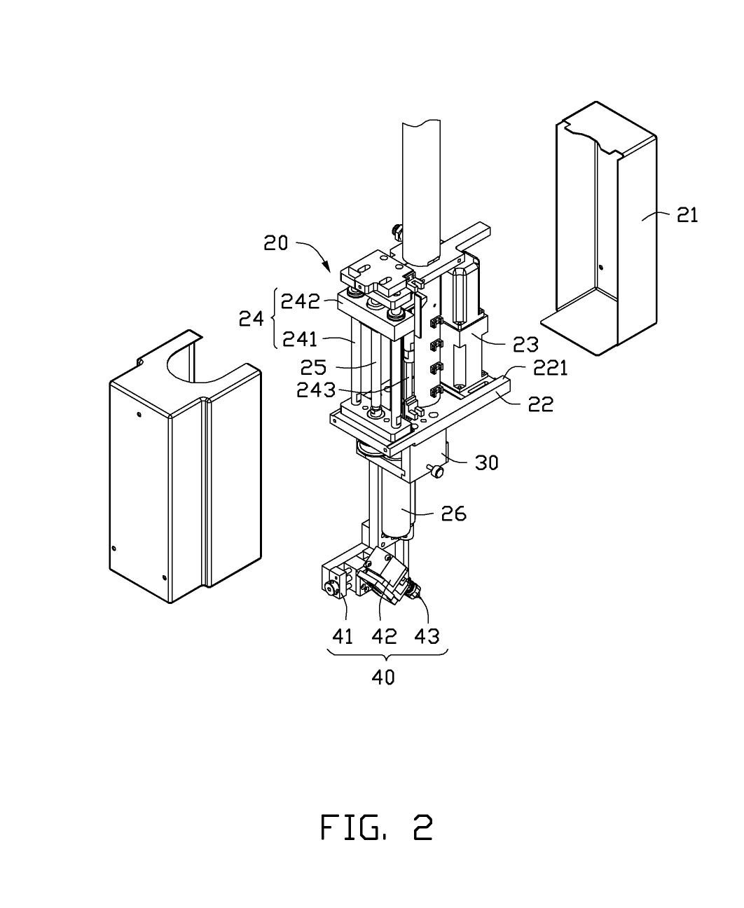

Referring to FIGS. 1-2, an exemplary embodiment of a mounting assembly 30 is for removably mounting of an adhesive container 26 on an adhesive dispenser 100. The adhesive dispenser 100 includes a worktable 10, a driving assembly 15, a pushing assembly 20, the mounting assembly 30, and a dispensing assembly 40. The driving assembly 15 is fixed to the worktable 10. The pushing assembly 20 is mounted to and driven by the driving assembly 15 to move to the dispensing assembly 40. The dispensing assembly 40 is mounted to the mounting assembly 30 to dispense adhesive to workpiece(s) (not shown) positioned on the worktable 10.

The worktable 10 includes a control device (not shown), a supporting assembly 11, and a bracket 12. The supporting assembly 11 is mounted on the worktable 10 to support the workpiece(s). The bracket 12 includes two posts 121 assembled on the worktable 10, and a connecting rod 122 connecting to the two posts 121. The driving assembly 15 is mounted on the connecting rod 122, and includes a driving rod 151. The pushing assembly 20 is mounted to the driving rod 151. The control device electrically connects to the driving assembly 15, thereby driving the pushing assembly 20 to move towards the workpiece(s) along the driving rod 151.

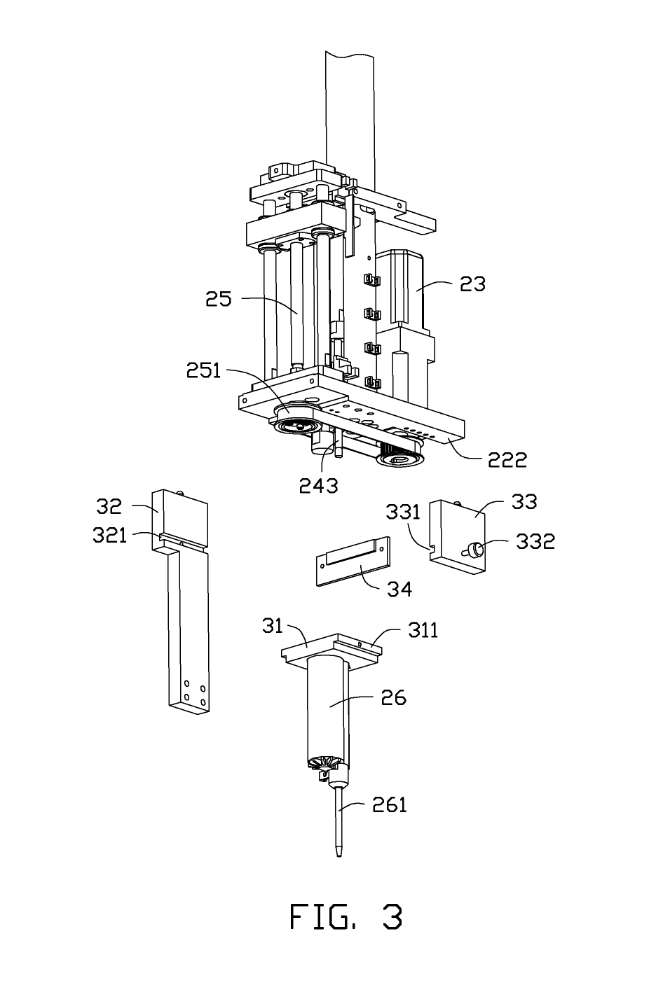

Referring to FIGS. 2 and 3, the pushing assembly 20 includes a cover 21, a supporting board 22, a motor 23, a sliding member 24, a guiding screw 25, and the adhesive container 26.

The supporting board 22 is mounted on a free end of the driving rod 151. The supporting board 22 includes a top surface 221 and a bottom surface 222. The motor 23 and the sliding member 24 are mounted on the top surface 221 and located on opposite sides of the driving rod 151. The sliding member 24 includes two sliding rods 241, a sliding block 242, and a pushing rod 243. The pushing rod 243 has an end mounted on the sliding block 242, and an opposite end extending through the supporting board 22 and received in the adhesive container 26, to push adhesive out of the adhesive container 26. The guiding screw 25 is located between the two sliding rods 241 and extends through the supporting board 22 to connect to the motor 23 through a conveyer belt 251. The sliding block 242 passes through the two sliding rods 241 and the guiding screw 25.

The mounting assembly 30 includes a sliding board 31, a first fixing board 32, a second fixing board 33, and a connecting board 34. The first fixing board 32 and the second fixing board 33 are mounted on the bottom surface 222 of the supporting board 22 by the connecting board 34. The sliding board 31 is slidably attached to the first fixing board 32 and the second fixing board 33.

The sliding board 31 has a through hole (not shown), and sliding rails 311 positioned on opposite sides thereof. The adhesive container 26 has one end removably mounted in the through hole of the sliding board 32, and an opposite end having an tube 261 protruding therefrom.

The first fixing board 32 includes a first sliding groove 321. One surface of the second fixing board 33 opposite to the first fixing board 32 defines a second sliding groove 331 corresponding to the first sliding groove 321. A locking element 332 is detachably fixed to the opposite surface of the second fixing board 33. The locking element 332 is a screw or a pin. The locking element 332 extends through the second sliding groove 331 to lock the sliding board 31 on the second fixing board 33. The adhesive container 26 is slidably attached to the supporting board 22 via the two sliding rails 311 slidably receiving in the first and second sliding grooves 321 and 331. The pushing rod 243 extends through the supporting board 22 and is received in the adhesive container 26, to push adhesive out of the tube 261. The first fixing board 32 and the second fixing board 33 are substantially rectangular.

The dispensing assembly 40 includes a positioning member 41, an adjusting member 42, and a dispensing pin 43. The positioning member 41 is mounted on the first fixing board 32 and adjacent to the tube 261. The adjusting member 42 is movably mounted to the positioning member 41. The dispensing pin 43 is mounted to the adjusting member 42 and inclines downwards relative to positioning member 41. The tube 261 is aligned with the dispensing pin 43, thereby adhesive can be pushed out of the dispensing pin 43 through the tube 261.

In use, workpieces are positioned on the worktable 10. The dispensing assembly 40 is turned on. The motor 23 rotates the guiding screw 25 to force the sliding block 242 to slide along the two sliding rods 241, thereby forcing the pushing rod 243 to slide towards the adhesive container 26 and push adhesive out of the dispensing pin 43 through the tube 261. When replacing the adhesive container 26, the locking element 332 is detached from the second fixing board 33 so the sliding board 31 can slip out of the first sliding groove 321 and the second sliding groove 331. Thus, the adhesive container 26 can be easily removed and replaced by users.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

What is claimed is:

1. An mounting assembly for adhesive dispenser, comprising:
a sliding board defining two sliding rails on two opposite sides thereof, the adhesive container being mounted on the sliding board;
a first fixing board defining a first sliding groove; and
a second fixing board defining a second sliding groove corresponding to the first sliding groove, the first fixing board and the second fixing board being mounted on the adhesive dispenser and located opposite to each other, the sliding board being slidably attached to the first fixing board and the second fixing board via the two sliding rails slidably receiving in the first, second sliding grooves.

2. The mounting assembly of claim 1, further comprising a locking element detachably fixed to the opposite surface of the second fixing board, wherein the locking element extends through the second sliding groove to releasably lock the sliding board on the second fixing board.

3. The mounting assembly of claim 1, wherein the sliding board defines a through hole, the adhesive container has one end removably mounted in the through hole and an opposite end having a circular tube protruded therefrom.

4. An adhesive dispenser, comprising:
a worktable;
a driving assembly assembled on the worktable;
a pushing assembly mounted on and driven by the driving assembly to move to the dispensing assembly, the pushing assembly comprising an adhesive container;
a mounting assembly slidably assembled to driving assembly, the adhesive container being removably mounted on the adhesive dispenser by the mounting assembly, and
a dispensing assembly mounted to the mounting assembly to dispenses adhesive to workpiece(s) positioned on the worktable.

5. The adhesive dispenser of claim 4, wherein the mounting assembly comprises a sliding board, a first fixing board, and a second fixing board, the sliding board comprises two sliding rails on two opposite sides thereof, the adhesive container is mounted on the sliding board; the first fixing board comprises a first sliding groove; the second fixing board defines a second sliding groove corresponding to the first sliding groove, the first fixing board and the second fixing board are mounted on the adhesive dispenser and opposite to each other, the sliding board is slidebly attached to the first fixing board and the second fixing board with the two sliding rails slidably receiving the first, second sliding grooves.

6. The adhesive dispenser of claim 5, wherein the mounting assembly further comprises a locking element detachably fixed to the opposite surface of the second fixing board, wherein the locking element extends through the second sliding groove and releasably locks the sliding board on the second fixing board.

7. The adhesive dispenser of claim 5, wherein the sliding board defines a through hole, the adhesive container has one end removably mounted in the through hole and an opposite end having a circular tube protruded therefrom.

8. The adhesive dispenser of claim 7, wherein the pushing assembly further comprises a supporting board, the supporting board comprises a top surface and an opposite bottom surface, the first fixing board and the second fixing board are mounted on the bottom surface, the first sliding groove is defined on a surface of the first fixing board, the second sliding groove is defined on a surface of the second fixing board and located opposite to the first sliding groove.

9. The mounting assembly of claim 5, wherein the pushing assembly further comprises a sliding member mounted on the supporting board, the sliding member comprises a pushing rod, the pushing rod extends through the supporting board and is received in the adhesive container to push adhesive out of the adhesive container.

10. The mounting assembly of claim 9, wherein the sliding member comprises two sliding rods and a sliding block, the press assembly further comprises a guiding screw and a motor mounted on the supporting board, the guiding screw is located between the two sliding rods and passes through the supporting board to connect to the motor by a conveyer belt, the sliding block passes through the two sliding rods and the guiding screw, the guiding screw drives the sliding block to make the pushing rod slide toward the adhesive container.

11. The mounting assembly of claim 10, wherein the dispensing assembly comprises a dispensing pin mounted on the first fixing board and adjacent to the tube of the adhesive container, the tube communicates with the dispensing pin to make adhesive pressed by the pushing rod flow out of the dispensing pin.
